(19) United States
(12) Patent Application Publication
(10) Pub. No.: US 2023/0071670 A1
(43) Pub. Date: Mar. 9, 2023

(54) Valve

(71) Applicant: AptarGroup, Inc., Crystal Lake, IL (US)

(72) Inventors: Dave Gaus, Midland, MI (US); Mark Honard, Midland, MI (US)

(21) Appl. No.: 17/797,923

(22) PCT Filed: Mar. 17, 2020
(86) PCT No.: PCT/US2020/023102

§ 371 Date: Aug. 5, 2022

(51) Int. Cl. F16K 15/14

(52) U.S. Cl. CPC F16K 15/148

(57) ABSTRACT

A valve (100, 200, 300) includes a body (104, 204, 304) with a first side surface (120, 220, 320), a second side surface (124, 224, 324), and a flow passage (128, 228, 328) extending through the body (104, 204, 304) to define a flow passage opening (136, 236, 336) at the second side surface (124, 224, 324). The body (104, 204, 304) includes a valve seat (148, 248, 348) that encompasses the flow passage opening (136, 236, 336). The valve includes a valve member (108, 208, 308) having an anchor (152, 252, 352) mounted on the body (104, 204, 304) and a flange (156, 256, 356) extending from the anchor (152, 252, 352) defining a seal portion (184, 284, 384) for sealing against the valve seat (148, 248, 348). The valve includes a fulcrum (112, 212, 312) located between the flange (156, 256, 356) and the second side surface (124, 224, 324).

### TECHNICAL FIELD

The present invention relates generally to a valve for controlling the flow of one or more fluent substances.

### BACKGROUND OF THE INVENTION AND TECHNICAL PROBLEMS POSED BY THE PRIOR ART

Some valves include a relatively flexible, resilient valve member that can be mounted to a relatively rigid body or wall of a vessel or other container. The body might separate the interior of the container from the exterior of the container, or, alternatively, the body might separate different chambers within a vessel or other container. The body may be provided with one or more flow passages extending through the body to accommodate the flow of a fluent substance or substances (e.g., liquids, gases, solid particles) between opposite sides of the valve through the flow passages. The valve may be normally closed, whereby some portion of the flexible valve member seals against a surface of the body, around the flow passages, when the pressure differential between the opposite sides of valve does not exceed a pre-determined value. The normally closed valve inhibits, or substantially prevents, flow of the fluent substance through the valve from one side to the other.

When the pressure differential between opposite sides of the valve exceeds the pre-determined value, then a higher pressure on one side of the valve overcomes the natural resiliency of the flexible valve member, moving it away from the surface of the body to expose the flow passages. Exposure of the flow passages accommodates flow of the fluent substance from the higher-pressure side of the valve to the lower-pressure side of the valve. Resiliency of the valve member returns the valve member to seal against the body when the pressure differential between opposite sides of the valve drops below the pre-determined value.

One such valve is an umbrella check valve, which includes a flexible, resilient valve member having an umbrella-like shape that is defined by (1) an elongate, central portion with a proximal end and a distal end for being mounted at an opening in a container, and (2) an annular sealing flange that extends laterally outwardly from the proximal end of the central portion for sealing over the container opening.

The umbrella-shaped valve member defines a unidirectional check valve which opens to permit flow therethrough when the pressure on the underside or bottom of the annular sealing flange exceeds a pressure on the top side or top of the flange.

Forms of such types of umbrella check valves are disclosed in the U.S. Pat. Nos. 5,507,318; 6,951,295; and 7,243,676. The descriptions of those patents are incorporated herein by reference thereto to the extent pertinent and to the extent not inconsistent herewith.

The inventors of the present invention have discovered that, in at least some applications, it would be desirable to provide an improved valve, containing an umbrella-type valve member mounted on a body, that is not limited to functioning as a unidirectional valve, and which may selectively function as a bi-directional valve in a different mode of operation.

The inventors of the present invention have further determined that for at least some applications, it may be desirable to provide such an improved valve that can be easily assembled, disassembled, and/or cleaned.

The inventors of the present invention have also determined that for at least some applications, it may be desirable to provide a valve having both (1) a normally closed condition, and (2) a mechanically maintainable open condition when the valve member is mechanically engaged by a user of the valve or a sufficiently rigid article).

The inventors of the present invention have also determined that it would be desirable to provide, at least for some applications, an improved valve that can be configured for use with a fluent substance container so as to have one or more of the following advantages: (1) ease of manufacture and/or assembly, (2) relatively low cost of manufacture and/or assembly, (3) low unit-to-unit variability of the required valve opening force exerted by an engaging article or user of the valve, and (4) accommodation of the manufacture of the valve by means of efficient, high-quality, large-volume techniques with a reduced product reject rate to produce valves with consistent operating characteristics.

The inventors of the present invention have discovered how to provide such a valve that includes novel, advantageous features not heretofore taught or contemplated by the prior art, and which can accommodate designs having one or more of the above-discussed benefits or features.

### BRIEF SUMMARY OF THE INVENTION

The inventors of the present invention have discovered how to provide an improved valve for permitting selective flow through the valve (from one side to the other). The valve may be assembled with a container of a fluent substance (such as ostomy pouch or bag), or it may be incorporated into some other type of fluent substance processing system (such as a vessel for a mixer), that has an opening between the exterior and interior of the container or system.

According to one aspect of the invention, the valve is normally closed and can (i) automatically open to establish communication through the valve between first and second sides of the valve in response to a pressure on the first side of the valve exceeding the pressure on the second side of the valve by a predetermined amount, and (ii) be selectively opened to establish communication through the valve between the first and second sides of the valve. The valve includes a body that defines a first side surface and a second side surface. The body defines at least one flow passage extending therethrough between the first side surface of the body and the second side surface of the body to define (i) a flow passage opening at the body first side surface, and (ii) a flow passage opening at the body second side surface. The body further includes a valve seat that (i) is located on the body second side surface, and (ii) encompasses the flow passage opening at the body second side surface.

The valve includes a movable valve member that has an anchor that is mounted on the body to accommodate movement between (i) an initially installed first location relative to the body, and (ii) a selectively mechanically maintainable second location relative to the body. The valve member further includes a deflectable, resilient flange that (i) extends laterally from the anchor, and (ii) defines a seal portion for effecting a sealing engagement with the valve seat on the body second side surface around the flow passage opening at the body second side surface when the anchor is in the first location relative to the body while the pressure on the first side of the valve does not exceed the pressure on the second side of the valve by more than a predetermined amount.

The valve includes a fulcrum located at one of the valve member and the body between the valve member flange and the body second side surface whereby the valve can be selectively opened by pushing the anchor relative to the body toward the second location to pivot at least a portion of the valve member flange about the fulcrum and thereby deflect at least part of the seal portion out of sealing engagement with the valve seat on the body second side surface to open the valve to establish communication through the valve between the first and second sides of the valve.

According to another aspect of the invention, the body is a part of a container that can be subjected to a first pressure on the exterior of the container that exceeds a second pressure on the interior of the container. The valve member flange is located at the exterior of the container.

According to another aspect of the invention, the body has a plurality of flow passages arranged to extend between the body first and second side surfaces. Each of the flow passages defines a flow passage opening at the body second side surface so that the flow passage openings at the body second side surface lie on a circular locus on the body second side surface.

According to still another aspect of the invention, the valve member flange is a flexible, resilient membrane that has a generally circular configuration extending from the anchor. The valve member seal portion is an annular lip for sealingly engaging the valve seat around the plurality of the flow passage openings at the body second side surface.

In one form of the invention, the body defines a mounting aperture extending between the first and second side surfaces of the body. The valve member anchor has (i) a middle portion received in the mounting aperture, (ii) a first end portion extending beyond the mounting aperture at the body first side surface, and (iii) a second end portion extending beyond the mounting aperture at the body second side surface. The valve member flange is located adjacent the body second side surface and extends from the anchor second end portion. The anchor first end portion is enlarged and extends adjacent to, and engages, said body first side surface for inhibiting movement of the anchor first end portion through the mounting aperture in a direction from said body first side surface toward the body second side surface.

According to another form of the invention, the valve member flange is sufficiently resilient so that the seal portion can engage the body valve seat with a sealing force to bias the valve member anchor to the first location wherein the anchor enlarged first end portion is pulled against the body first side surface adjacent the mounting aperture to maintain the valve member anchor at the first location unless the valve member anchor is moved with an external force sufficient to overcome the bias.

According to yet another aspect of the invention, the fulcrum is a post projecting from the body second side surface toward the valve member flange.

According to another aspect of the invention, the fulcrum is a post projecting from the valve member flange toward the body second side surface.

In one form of the invention, the fulcrum is an annular wall that (i) projects from the body second side surface toward the valve member flange, and (ii) extends around the flow passage opening at the body second side surface. The annular wall defines at least one channel therein to accommodate flow through the channel when the valve member flange engages the annular wall.

In yet another aspect of the invention, the fulcrum is an annular wall that (i) projects from the valve member flange toward said body second side surface around the flow passage opening at the body second side surface, (ii) is spaced laterally from the valve member seal portion, and (iii) is configured to engage the body second side surface around the flow passage opening at the body second side surface. The annular wall defines at least one channel therein to accommodate flow through the channel when the annular wall engages the body second side surface around the flow passage opening at the body second side surface.

According to another aspect of the invention, the valve member is formed from Silicone having a durometer of about 40 shore A.

According to yet another aspect of the invention, the valve member flange includes a top surface that faces away from the body second side surface, and which defines a first radius of curvature. The flange includes a bottom surface that faces the body second side surface, and that defines a second radius of curvature. The second radius of curvature is greater than the first radius of curvature.

According to another aspect of the invention, the valve is configured to automatically open to establish communication through the valve when the pressure on the first side of the valve exceeds the pressure on the second side of the valve by about 20,600 Pascal.

According to another aspect of the invention, the valve member is mechanically maintainable in the second location relative to the body when the valve anchor is subjected to a predetermined compressive force threshold.

In one form of the invention, the anchor defines a central axis, and the fulcrum is located radially outwardly of the flow passage opening at the body second side surface, as measured from the central axis.

In one form of the invention, the fulcrum has the form of four rounded posts located on one of the valve member or the body second side surface. Each post is located on a circular locus.

According to one form of the invention, the body includes four flow passages, each of which has the form of an arcuate slot extending between the first and second side surfaces of the body.

In one form of the invention, the body is a molded thermoplastic insert for a container that can be subjected to a first pressure on the exterior of the container that exceeds a second pressure on the interior of the container. The valve member is a molded elastomer and is arranged with the body such that the flange is located at the exterior of the container.

According to one particular form of the invention, the valve includes body having a first side surface and a second side surface. The body defines at least one flow passage extending through the body between the first and second side surfaces to define (i) a flow passage opening at the body first side surface, and (ii) a flow passage opening at the body second side surface.

The particular form of the valve further includes a valve member that (i) is movable relative to the body, and (ii) includes a flexible and resilient flange having a first region, a second region extending from the first region, and a third region extending from the second region. The third region includes a seal portion configured so that the seal portion sealingly engages the body second side surface around the flow passage opening at the body second side surface when the valve is in an initially closed condition to prevent communication through the valve.

The particular form of the valve further includes a fulcrum that is located on one of the valve member and the body between the valve member flange second region and the body second side surface, whereby if the valve member is pushed relative to the body to move the valve member flange first region toward the body second side surface, then the valve member flange second region pivots about the fulcrum to deflect at least part of the sealing portion of the valve member flange third region out of sealing engagement with the body second side surface to establish communication through the valve.

Numerous other advantages and features of the present invention will become readily apparent from the following detailed description of the invention, from the claims, and from the accompanying drawings.

### BRIEF DESCRIPTION OF THE DRAWINGS

In the accompanying drawings forming part of the specification, in which like numerals are employed to designate like parts throughout the same,

FIG. 1 is an enlarged, fragmentary, isometric view, taken from above, of a first embodiment of a valve according to the present invention, and FIG. 1 shows a valve member in an unstressed, closed position and assembled with a fragmentary portion of the body of the valve;

FIG. 2 is an enlarged, fragmentary, isometric view, taken from below, of the valve of FIG. 1;

FIG. 3 is an enlarged, fragmentary, exploded, isometric view, taken from above, of the valve of FIG. 1;

FIG. 4 is an exploded, fragmentary, isometric view, taken from below, of the valve of FIG. 1;

FIG. 5 is an enlarged, fragmentary, top plan view of the valve of FIG. 1;

FIG. 6 is an enlarged, fragmentary, bottom plan view of the valve of FIG. 1;

FIG. 7 is an enlarged, fragmentary, cross-sectional view of the valve of FIG. 1, taken along plane 7-7 in FIG. 5;

FIG. 8 is an enlarged, fragmentary, cross-sectional view of the valve of FIG. 1, taken along plane 8-8 in FIG. 5;

FIG. 8A is an enlarged, fragmentary, cross-sectional view of the valve of FIG. 1, taken along plane 8-8 in FIG. 5, however FIG. 8A shows the valve in a first open position caused by an over-pressure condition on the first side of the valve;

FIG. 9 is an enlarged, fragmentary, top plan view of the valve of FIG. 1, however FIG. 9 shows the valve in a second open position caused by engagement with a user's finger on the top side of the valve (the finger not being illustrated in FIG. 9);

FIG. 10 is an enlarged, fragmentary, cross-sectional view of the valve of FIG. 1, taken along plane 10-10 in FIG. 9, and FIG. 10 shows the valve in a second open position caused by engagement with a user's finger on the top side of the valve;

FIG. 11 is an enlarged, fragmentary, cross-sectional view of the valve of FIG. 1, taken along plane 11-11 in FIG. 9, and FIG. 11 shows the valve in a second open position caused by engagement with a user's finger on the top side of the valve;

FIG. 12 is an enlarged, fragmentary, top plan view of a second embodiment of a valve according to the present invention, and FIG. 12 shows the second embodiment of the valve member in an unstressed, closed position assembled with a fragmentary portion of a body of the valve;

FIG. 13 is an enlarged, fragmentary, exploded, isometric view, taken from below, of the valve of FIG. 12;

FIG. 14 is an enlarged, fragmentary, cross-sectional view of the valve of FIG. 12, taken along plane 14-14 in FIG. 12;

FIG. 15 is an enlarged, fragmentary, cross-sectional view of the valve of FIG. 12, taken along plane 15-15 in FIG. 12;

FIG. 16 is an enlarged, fragmentary, exploded, isometric view, taken from above, of a third embodiment of a valve according to the present invention;

FIG. 17 is an enlarged, fragmentary, top plan view of the valve of FIG. 16, and FIG. 17 shows a valve member in the unstressed, closed position; and

FIG. 18 is an enlarged, fragmentary, cross-sectional view of the valve of FIG. 16, taken along plane 18-18 in FIG. 17.

### DESCRIPTION OF THE PREFERRED EMBODIMENTS

While the valve of the present invention is susceptible of embodiment in many different forms, this specification and the accompanying drawings disclose only some specific forms as examples of the invention. The invention is not intended to be limited to the embodiments so described, however.

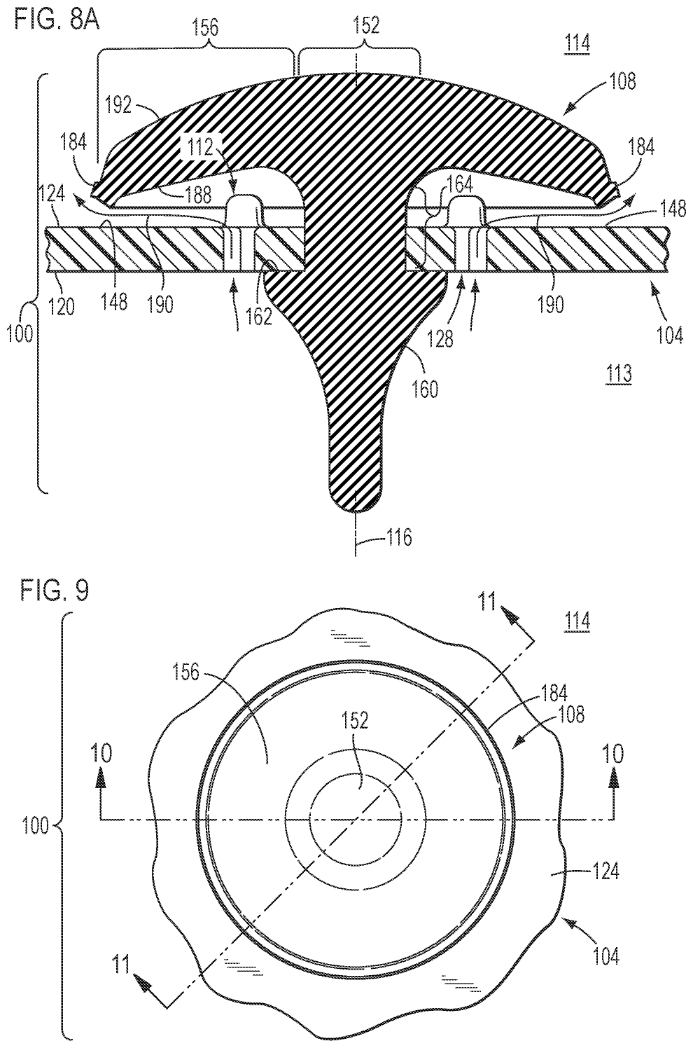

FIGS. 1-11 illustrate a first embodiment of a valve according to the present invention, which is designated by the numeral 100. With reference to FIG. 8, the valve 100 has three primary functional elements: (i) a body 104; (ii) a valve member 108; and (iii) a fulcrum 112. The valve 100 can be used for selectively permitting communication of one or more fluent substances (e.g., gases, liquids, solid particles) through the valve 100, between a first side 113 of the valve 100 and a second side 114 of the valve 100 (in one or both directions). The valve 100 would typically be located at an opening between the interior and the exterior of a container, chamber, or system. The body 104 could be part of, or integral with, such a container, chamber, or system. Alternatively, the body 104 could be an insert or separate part for being affixed to, or otherwise retained at, an opening in the container, chamber, or system.

The valve 100 is especially adapted to be installed on a container wherein the interior of the container is, at times, subjected to a vacuum, and wherein a user of the valve 100 may selectively engage, either directly or indirectly, a portion of the valve 100 that is located on the exterior of the container, to move some portion of the valve 100 to allow the flow of a fluent substance (e.g., air) from the exterior of the container into the interior of the container.

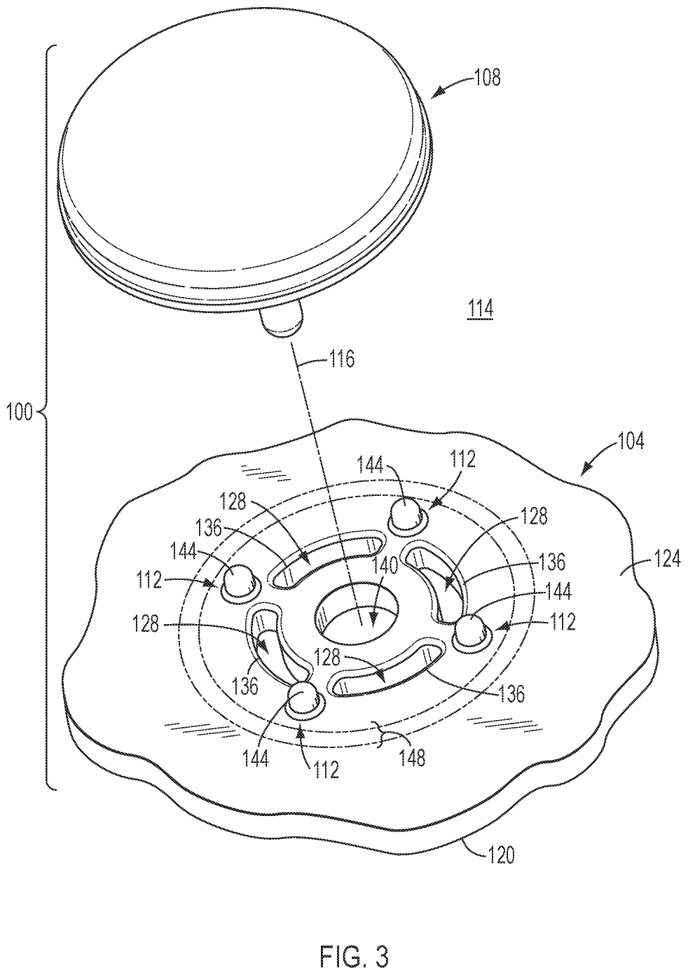

For ease of description, the valve of this invention is described, with reference to the drawings, in a generally horizontal orientation that the valve could have when installed on a fluent substance container or system for being engaged by a user or a sufficiently rigid article, wherein the user or article can contact the valve from above to move some portion of the valve downward. The terms “axial”, “radial”, and “lateral” are used herein with respect to an axis 116 (FIGS. 3, 7, 8) that extends generally vertically through the center of the valve member 104. As employed herein, the phrase “axially outwardly” refers to the direction upwardly in the figures, along the axis 116. The phrase “axially inwardly” refers to the direction downwardly in the figures, along the axis 116. As employed herein, the phrase “radially inwardly” refers to a direction normal to, and moving toward, the axis 116. The phrase “radially outwardly” refers to a direction normal to, and moving away from, the axis 116. The phrase “laterally outwardly” refers to a direction away from the axis 116, and also within a plane that is normal to the axis 116. It will be understood, however, that the valve 100 of this invention may be manufactured, stored, transported, used, or sold in orientations other than the orientation shown.

The valve 100 is suitable for use with a variety of conventional or special fluent substance containers or systems (e.g., fluent substance handling or processing systems, dispensing systems, etc.) having various designs, the details of which, although not illustrated or described, would be apparent to those having skill in the art and an understanding of such containers or systems. The container may be, for example, a rigid bottle or a flexible bag. The valve 100 could also be installed on a reservoir, a fluent substance processing system, or a fluent substance dispensing system, which contains a fluent substance below ambient atmospheric pressure, at ambient atmospheric pressure, or above ambient atmospheric pressure (including a system in which the pressure results from the static head of the fluent substance within the system and/or in which the system generates or otherwise creates a pressurized fluent substance therein).

The valve 100 could be operated mechanically (i.e., manually) by a user of the valve 100, or may be operated by a mechanism, probe, or other article that is sufficiently rigid to deflect some portion of the valve 100 to open the valve 100. While such a mechanism, probe, or article is not illustrated, such features could be readily designed by one skilled in the art. The detailed descriptions of such features are not necessary to an understanding of the invention, and accordingly, are herein discussed only to the degree necessary to facilitate an understanding of the novel aspects of the present invention.

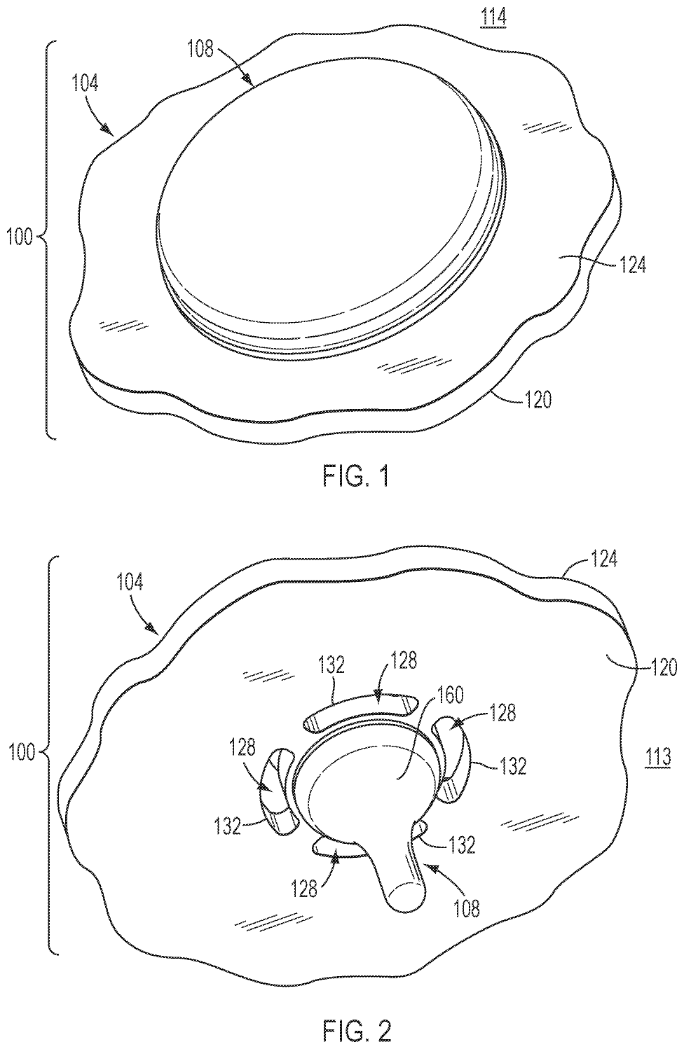

With reference to FIGS. 1 and 2, the body 104 of the valve 100 is only partially shown. The body 104 could be an insert or receiver for being secured at or across an opening in a container, or could be an integral part of a container. It will be appreciated that the body 104 may have any suitable shape or thickness. For example, the body 104 could have the form of a thermoplastic disc or thin-walled part for being removably secured to an opening in a separate container by way of a snap-fit connection. For some applications, the insert could be non-removably secured to the container by way of an adhesive, weld, press-fit, etc. Alternatively, the body 104 could be a portion of a wall within, or on the exterior of, the container itself. While the body 104 is preferably molded or otherwise formed from a sufficiently rigid thermoplastic (e.g., polypropylene or polyethylene), other materials, such as metals, or composites could be used for the body 104. In one presently preferred form, the body 104 is a relatively rigid fitting or port connected at an opening to a flexible ostomy bag or pouch, wherein the valve 100 may be engaged by user to allow ingress or egress of a fluent substance between opposite sides of the body 104.

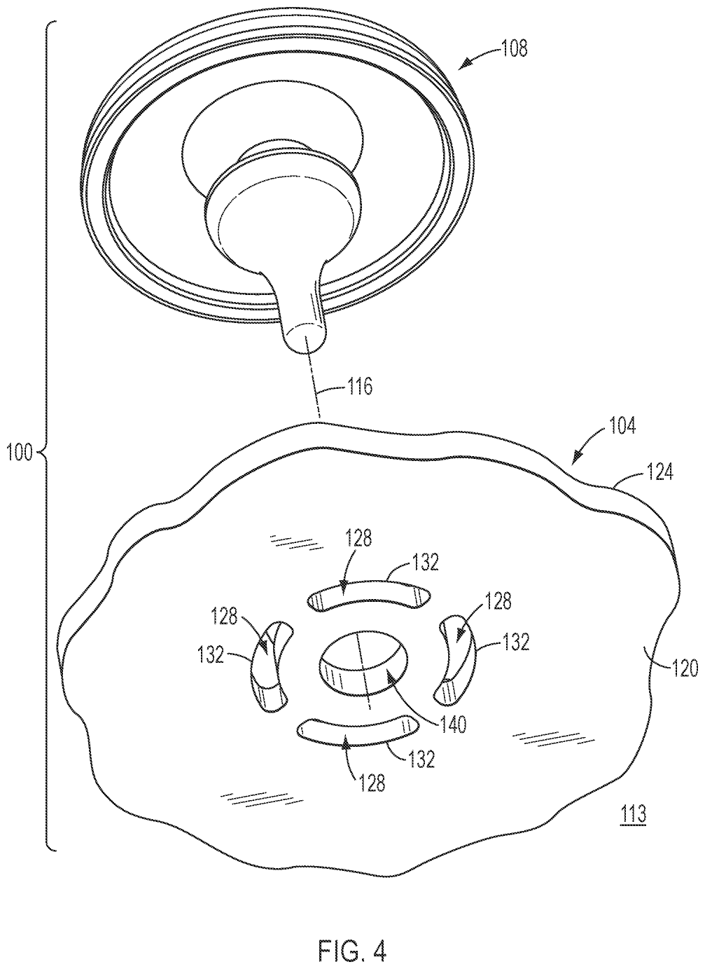

With reference now to FIGS. 3 and 4, the body 104 defines a first side surface 120 and a second side surface 124. In one presently preferred application of the valve 100, the first side surface 120 faces the interior of a container (which is selectively subjected to a vacuum), and the second side surface 124 faces the exterior of the container (which is normally at ambient atmospheric pressure). The body 104 defines four flow passages 128, each of which is generally in the form of an arcuate slot that is centered on the axis 116. Each flow passage 128 defines a flow passage opening 132 (FIG. 4) on the first side surface 120 of the body 104 and a flow passage opening 136 (FIG. 3) on the second side surface 124 of the body 104. Each flow passage 128 extends in a direction parallel to the axis 116 through the thickness of the body 104, as can be seen in FIG. 8, but it will be appreciated that one or more of the flow passages 128 might extend in other directions through the body 104 and have other shapes (not illustrated).

Still referring to FIGS. 3 and 4, the body 104 defines a mounting aperture 140 for receiving a portion of the valve member 108 which will be discussed in detail hereinafter. The mounting aperture 140 is circular and centered on the axis 116.

With reference to FIGS. 3, 7, and 8, the fulcrum 112 of the first illustrated embodiment of the valve 100 has the form of four posts 112 that are located at, and extend from, the second side surface 124 of the body 104 toward the valve member 108. Each fulcrum post 112 has a rounded tip 144 for contacting a portion of the valve member 108, which will be discussed hereinafter. In addition, each fulcrum post 112 is located laterally outwardly beyond the flow passage openings 136 on the first side surface 124 of the body 104.

It will be understood that although the first illustrated embodiment of the valve 100 has a fulcrum 112 in the form of posts 112 that are unitary with the body 104, the fulcrum posts 112 need not be unitary with the body 104. For example, the fulcrum posts 112 could be separately formed from the body 104 and subsequently attached to the body 104 by a secondary manufacturing process (e.g., adhered with adhesive, bi-injection molded, welded, clamped, press-fit, etc.). Furthermore, the fulcrum posts 112 could instead be attached or formed integrally with the valve member 108 (instead of the body 104), as with other illustrated embodiments of the valve that are discussed hereinafter.

It will be further understood that while the fulcrum posts 112 of the first illustrated embodiment of the valve 100 has the form of four rounded posts extending from the body 104 toward the valve member 108, the fulcrum posts 112 need not be limited to such a shape for some applications. For example, the fulcrum 112 could have the form of a single post extending from either of the body 104 or the valve member 108. Alternatively, the fulcrum 112 could have the form of a wall extending from either of the body 104 or the valve member 108.

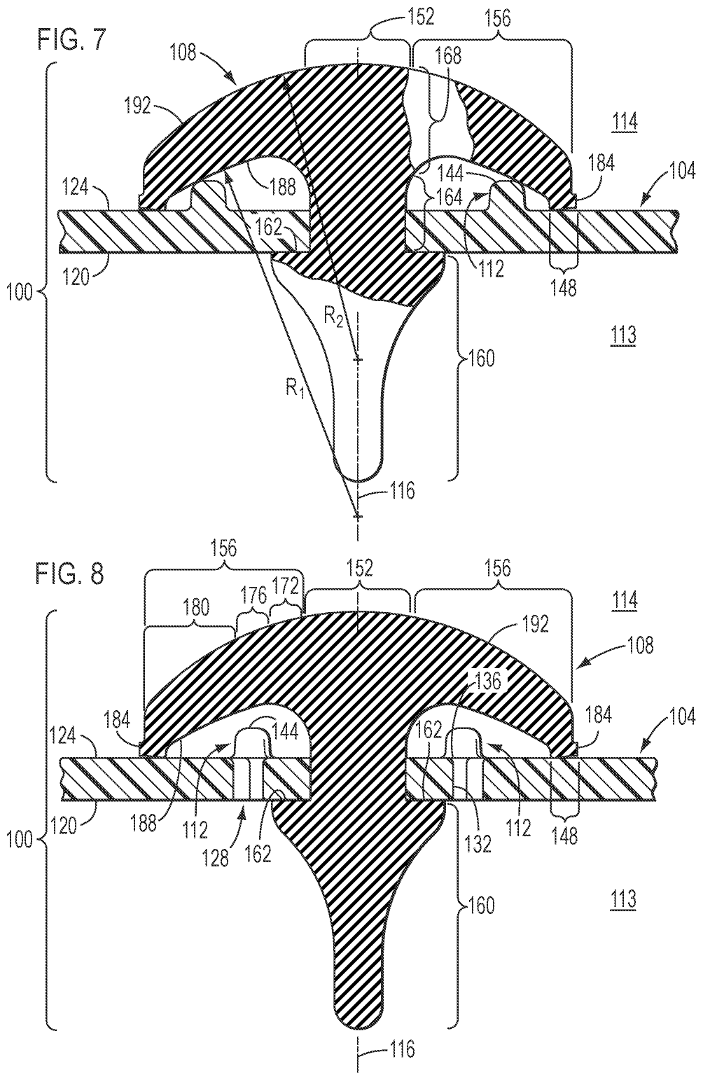

Still referring to FIGS. 7 and 8, the body 104 of the first illustrated embodiment of the valve 100 defines a circular valve seat 148 for cooperating with a portion of the valve member 108 to create a seal around the flow passages 128 when the valve 100 is closed (FIGS. 7 and 8). The valve seat 148 is located laterally outward of, and encompasses, the flow passage openings 136 on the second side surface 124 of the body 104. While the valve seat 148 of the first illustrated embodiment of the valve 100 has the form of a substantially flat surface on the body 104, the valve seat 148 could have other suitable shapes for cooperating with the valve member 108 to form a seal. For example, the valve seat 148 could be a raised on, or recessed surface within, the body 104. In addition, the valve seat 148 could be notched, ribbed, or textured to cooperate with mating features located on the valve member 108 to form a seal.

The valve member 108 of the illustrated first embodiment of the valve 100 has an umbrella-like configuration, and is flexible, resilient, pressure-openable, and self-closing. Forms of generally related kinds of umbrella valves are disclosed in the U.S. Pat. No. 6,951,295 B1 and International Publication No. WO 2014/089082 A1. The descriptions of those patents are incorporated herein by reference thereto to the extent pertinent and to the extent not inconsistent herewith.

The valve member 108 is suitable for use with fluent substances, such as liquids and gases, including, inter alia, beverages, food products, or mixtures. The valve member 108 is preferably molded as a unitary, or one-piece, structure from a material which is flexible, elastic, and resilient. This can include elastomers, such as a synthetic, thermosetting polymer, including silicone rubber, such as the silicone rubber sold by Dow Corning Corporation in the United States if America under the trade designation D.C. 99-595 and RBL-9595-40. Another suitable silicone rubber material is sold in the United States of America under the designation Wacker 3003-40 by Wacker Silicone Company.

The valve member 108 could also be molded from other thermosetting materials or from other elastomeric materials, or from thermoplastic polymers or thermoplastic elastomers, including those based upon materials such as thermoplastic propylene, ethylene, urethane, and styrene, including their halogenated counterparts. For example, a particular non-silicone material that may be employed is ethylene propylene diene monomer rubber (“EPDM”), such as sold in the United States of America under the designation Grade Z1118 by Gold Key Processing, Inc. having an office at 14910 Madison Road, Middlefield, Ohio 44062, United States of America. Another non-silicone material that may be employed is nitrile rubber, such as sold in the United States of America under the designation Grade GK0445081-2 by Graphic Arts Rubber, having an office at 101 Ascot Parkway, Cuyahoga Falls, Ohio 44223, United States of America. It is desirable in many applications that the material be substantially inert so as to avoid reaction with, and/or adulteration of, the fluent substance or substances that come into contact with the valve member 108.

While the illustrated valve member 108 is formed from a single material, it will be appreciated that for some applications the valve member 108 may be formed from a material that is defined by two or more layers of the same or different substances. For example, one layer of the valve member 108 material may be formed form a silicone rubber and one or more other layers of the valve member 108 material may be formed from coatings, treatments, or laminations of one or more different substances. As another example, the valve member 108 could be formed as a compound structure having some portions thereof formed from an elastomeric material and other portions formed from other materials such as a metal spring or rigid thermoplastic.

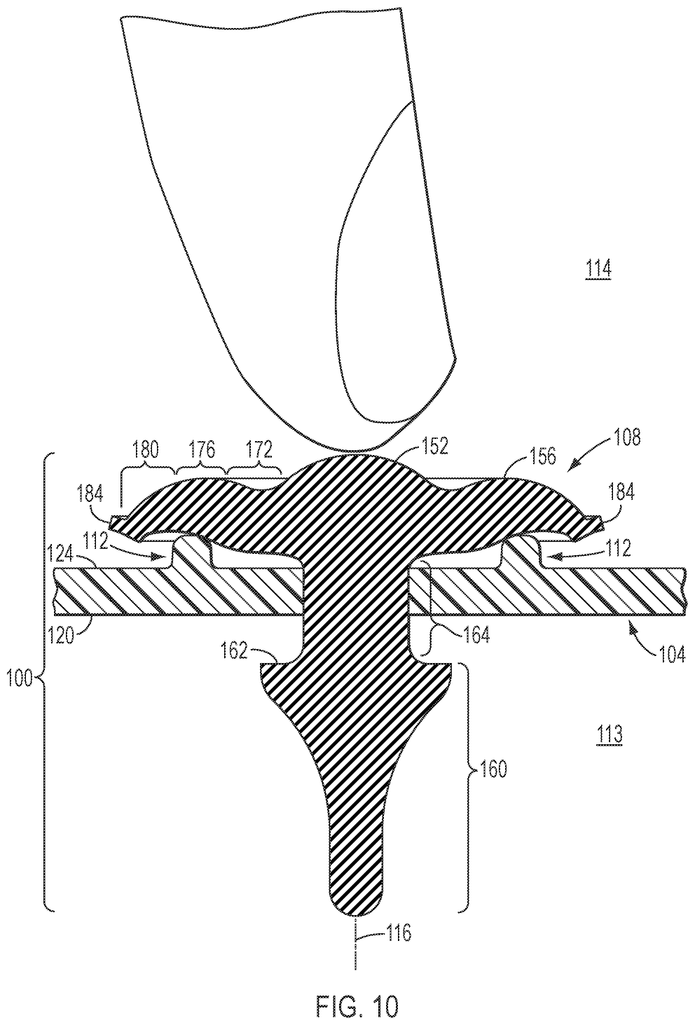

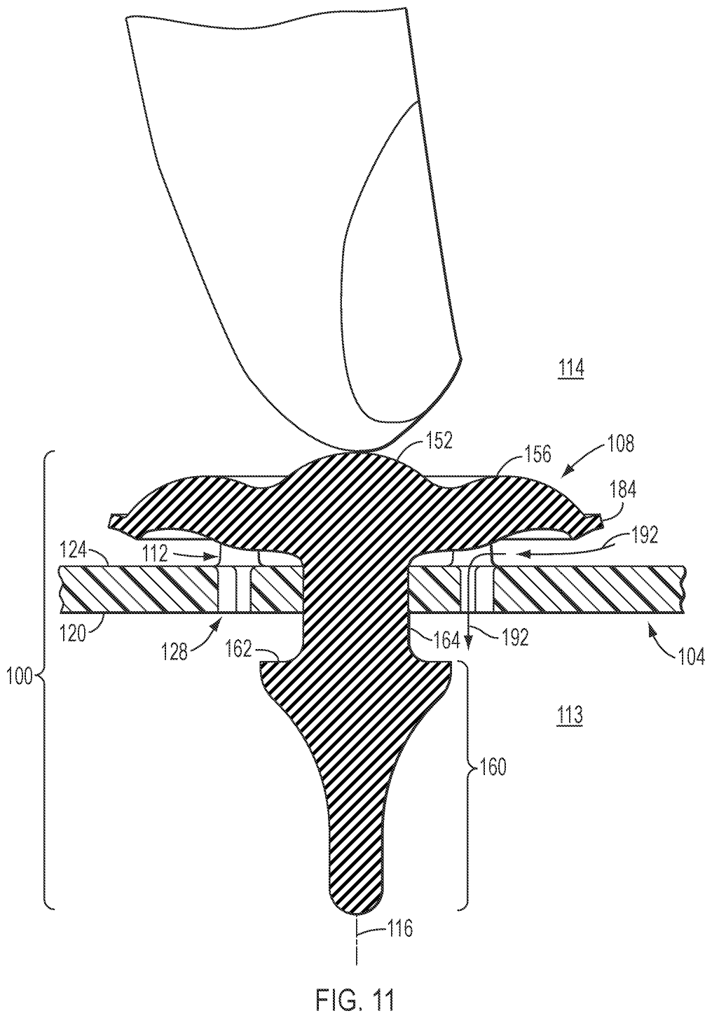

The valve member 108 has an as-molded, substantially unstressed, rest position or condition (FIGS. 3 and 4). In the assembled configuration (FIGS. 7 and 8) the valve member may be at least slightly stressed by its mounting arrangement on the valve body 104 such that a sufficiently fluid-tight seal is created during certain operational conditions as will be explained in detail hereinafter. The valve member 108 can open automatically in a first mode of operation, such as in response to an over-pressure condition beneath the valve member 108 (FIG. 8A). In addition, the valve member 108 can be selectively forced, either mechanically by a user's finger or a sufficiently rigid article, into another open position or condition in a second mode of operation (as shown in FIGS. 10 and 11) as described hereinafter.

With reference to FIGS. 7, 8, and 10, the valve member 108 has the primary components of an anchor 152 for being mounted to the body 104, and an annular flange 156 extending laterally outward from the anchor 152 for sealingly engaging the valve seat 148 on the body 104. The anchor 152 has an installed, slightly stressed configuration that is referred to in the claims as a “first location” relative to the body 104 (FIGS. 7 and 8). The anchor 152 further has a mechanically actuated or moved configuration that is referred to in the claims as a “second location” relative to the body 104 (FIG. 10).

Referring now to FIGS. 7, 8, 8A, and 10, the anchor 152 has an enlarged, first end portion 160 for being inserted fully through the mounting aperture 140 of the body 104 to locate the first end portion 160 at the first side surface 120 of the body 104. The enlarged, first end portion 160 defines a smooth, tapered tip and an arcuate, flaring portion that defines an abutment surface 162 (visible in FIGS. 7, 8, 8A, and 10), which prevents or inhibits movement of the first end portion 160 from returning back through the mounting aperture 140 subsequent to initial installation of the anchor 152 therethrough. The anchor 152 further has a middle portion 164 (FIG. 7) for being received within the mounting aperture 140 of the body 104. The anchor 152 also includes a second end portion 168 for being located adjacent the second side surface 124 of the body 104 and from which the valve member flange 156 extends.

It will be understood that the valve member 108 could be assembled with the body 104 in a manner other than that illustrated in FIGS. 7 and 8, whereby the valve member 108 need not be retained within an aperture 140 within the body 104 and from which the valve member flange 156 extends. For example, the anchor 152 of the valve member 108 could be adhered, clamped, molded, heat bonded, or otherwise attached to the body 104 at the second side surface 124 if some portion of the anchor 152 would otherwise accommodate deflection of the annular flange 156 to accommodate mechanical opening of the valve as discussed hereinafter.

With reference to FIG. 8, the valve member flange 156 defines an annular first region 172 connected directly to, and extending laterally from, the anchor 152. An annular second region 176 extends laterally from the annular first region 172 and terminates at an annular third region 180 at the laterally outward end of the flange 156. The terminal portion of the third region 180 includes a seal portion in the form of an annular lip 184 for making sealing contact against the valve seat 148 on the body 104 when the anchor 152 is in the first location relative to the body 104 (as shown in FIG. 8). More specifically, the resiliency of the flange 156 forces the lip 184 against the valve seat 148 and pulls the abutment surface 162 of the flange first end portion 160 against the body first side surface 120 to retain the anchor 152 in the first location so as to establish some amount of sealing force exerted by the sealing lip 184 against the valve seat 148. Owing to the inherent resiliency of the valve member 108, the valve 100 can be designed for a selected design basis minimum pressure differential acting across the valve so as to keep the valve closed until the pressure on the valve first side 113 exceeds the pressure on the valve second side 114 by the amount of the design basis minimum pressure differential. Further, when the pressure on the valve second side 114 exceeds the pressure on the valve first 113, the seal between the lip 184 and the valve seat 148 is fluid tight and prevents or minimizes any substantial communication between the first side 113 of the valve 100 and the second side 114 of the valve.

The flange 156 of the valve member 108 is preferably configured for use in a particular container or system, and a specific type of fluent substance, such as air, so as to achieve proper opening and closing of the valve 100 when valve member 108 is subjected to an opening pressure differential or a manual force. For example, the pressure, viscosity and density of any fluent substance on one or both sides 113, 114 of the valve 100 are factors to be considered. The rigidity and durometer of the valve member 108 material are additional factors to be considered. Preferably, the valve member 108 is formed from a Silicone material having a durometer of about 40 shore A. In some applications, however, the inventors have found that the durometer of the valve member 108 may be increased or decreased to achieve a pre-selected venting pressure.

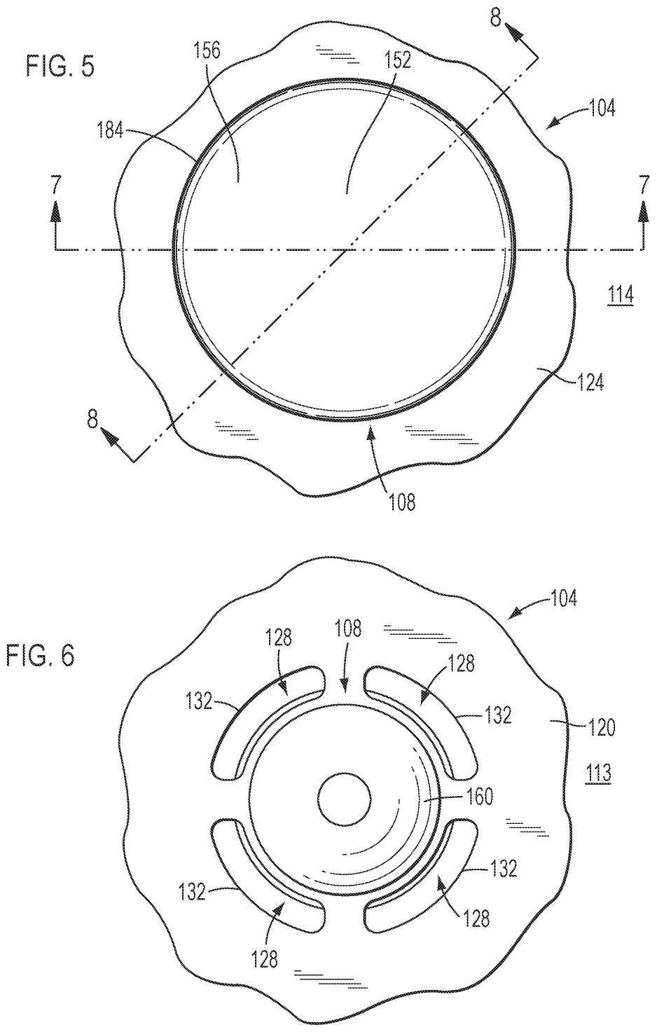

As can be seen in FIG. 5, the anchor 152 and the flange 156 of the valve member 108 have a generally circular configuration in plain view and have a generally concentric relationship relative to the central axis 116 (visible in FIG. 7). While the anchor 152 is illustrated as being generally cylindrical, and the flange 156 is illustrated as being generally annular, these structures may have other shapes. For example, the anchor 152 and/or flange 156 may be triangular, square, or have another polygonal shape. Furthermore, the anchor 152 and/or flange 156 may be asymmetric and/or irregularly shaped.

Referring now to FIG. 7, the flange 156 defines a bottom surface 188 having a generally concave configuration when the valve member 108 is mounted on the body 104, and the valve 100 is in the normally-closed condition, as viewed along a vertical cross-sectional plane through axis 116. The bottom surface 188 has a radius of curvature R₁. The flange 156 further defines a top surface 192 having a generally convex configuration when the valve member 108 is mounted on the body 104, and the valve 100 is in the normally closed condition, as viewed along a vertical cross-sectional plane through axis 116. The top surface 192 has a radius of curvature R₂. The radius of curvature R₂ of the top surface 192 is less than the radius of curvature R₁ of the bottom surface 188.

When the flange 156 is viewed in cross section, as illustrated in FIGS. 7 and 8, the annular first region 172 is thicker than the annular second region 176, which in turn is thicker than the annular third region 180. This configuration assists in providing a desirable opening action and closing action of the valve member 108 relative to the body 104 for a presently contemplated product application. In other product applications and/or design variations, the relative thicknesses of the three annular regions may be different.

The first illustrated embodiment of the valve 100 can be opened in a number of different ways. With reference to FIG. 8A, the valve 100 may function as a normally closed check valve that opens when the pressure on the first side 113 of the valve 100 (and under the flange bottom surface 188 laterally inwardly of the seal between the lip 184 and the valve seat 148) exceeds the pressure on the second side 114 of the valve 100 (outwardly of the seal lip 184) by a predetermined amount. When the pressure acting on the flange bottom surface 188 exceeds the inherent resiliency of the flange 156, and the countervailing pressure acting on the flange top surface 192, the flange 156 is lifted away from the body 104, separating the lip 184 from the valve seat 148. Separation of the lip 184 from the valve seat 148 exposes the flow passages 128 at the valve second side 114 and allows a fluent substance to flow (represented by the arrows 190 in FIG. 8A) through the valve 100, generally in the direction from the first side 113 (higher pressure side) of the valve 100, through the flow passages 128, and laterally outwardly beyond the lip 184 to the second side 114 (lower pressure side) of the valve 100.

In a presently contemplated commercial product, the first illustrated embodiment of the valve 100 is designed to remain substantially closed when the pressure differential between the valve first side 113 (higher pressure side) and the valve second side 114 (lower pressure side) remains below about 20,600 Pascal.

When the pressure differential between the valve first side 113 (higher pressure side) and the valve second side 114 (lower pressure side) falls below the predetermined amount, the valve 100 automatically returns to the closed position illustrated in FIGS. 7 and 8. Namely, the resiliency of the flange 156 forces the lip 184 to sealingly re-engage the valve seat 148 of the body 104 to re-establish the seal. Re-establishment of the seal encompassing the flow passages 128 prevents or minimizes flow of a fluent substance through the valve 100 from the valve first side 113 and the valve second side 114. In this manner, the valve 100 may serve as a normally closed check valve to (1) prevent flow from the valve second side 114 to the valve first side 113, and (2) open and permit flow from the valve first side 113 to the valve second side 114 in response to pressure at the valve first side 113 of the valve 100 that exceeds the pressure on the valve second side 114 by a predetermined amount (i.e., the pressure of the valve first side 113 must be great enough to overcome the pressure on the valve second side 114 plus the inherent closing force of the resilient sealing flange 156).

With reference now to FIGS. 10 and 11, the valve 100 may be opened or actuated in a second or alternative manner, when a finger or a sufficiently rigid article (not illustrated) is pressed against the top end of the anchor 152 of the valve member 108 with a force sufficient to deflect the valve member 108 relative to the body 104 by an amount that opens the valve seal. As the finger is pressed downwardly against the anchor 152 (FIG. 10), the anchor 152 and valve member flange 156 translate downwardly along the axis 116. The anchor middle portion 164 translates down through the mounting aperture 140 into a second location relative to the body 104 thereby moving the abutment surface 162 out of engagement with the body 104.

Still referring to FIGS. 10 and 11, the downward movement of the anchor 152 pulls the flange first region 172 (FIG. 10) toward the second side surface 124 of the body 104. Movement of the first region 172 toward the body 104 causes the flange second region 176 (FIG. 10) to contact the fulcrum posts 112. Contact between the fulcrum posts 112 and the flange second region 176 deflects the flange second region 176 upwardly to cause the flange third region 180 (FIG. 10) to move away (i.e., pivot upwardly) from the second side surface 124 of the body 104 to thereby disengage the sealing portion 184 from the valve seat 148 on the body 104. Separation of the lip 184 from the valve seat 148 exposes the flow passages 128 and allows a fluent substance to flow through the valve 100, and such flow may be in either direction depending on the relative pressures on the first side 113 and second side 114 of the valve 100. In FIG. 11, flow arrows 192 represent flow from a higher pressure on the second side 114 to a lower pressure on the first side 113.

When the externally-applied force acting against the anchor 152 falls below the predetermined amount (e.g., when the user removes the finger (FIG. 11)), the valve 100 automatically returns to the closed position illustrated in FIGS. 7 and 8. Namely, the resiliency of the anchor 152 and the flange 156 of the valve member 108 forces the valve member 108 to translate upwardly and to thereby disengage the flange second region 176 from contact with the fulcrum posts 112. Disengagement of the fulcrum posts 112 from the resilient flange second region 176 permits the flange second region 176 to return to its normally undeflected configuration and cause the flange third region 180 to return toward the body 104 such that the lip 184 reestablishes a seal with the valve seat 148 of the body 104. The lip 184 thus returns to sealingly encompass the flow passages 128 and close the valve 100 while translation of the anchor 152 upwardly returns the anchor 152 to the first position relative to the body 104 such that the anchor abutment surface 162 re-engages the body 104 and is maintained in the first position by the resilient engagement of the valve member flange 156 with the second surface 124 of the body 104 (FIG. 7).

In the first illustrated embodiment of the valve 100, the valve member 108 is designed to move relative to the body 104, into a mechanically maintainable, opened or actuated position (illustrated in FIGS. 10 and 11) when the top of the anchor 152 is subjected to a predetermined force threshold.

The inventors have found that providing an improved valve, such as the valve 100, which has multiple modes of operation, may be desirable for controlling the flow of a fluent substance or substances in a variety of containers or systems. In particular, the valve 100 may be especially suitable for use at an opening of a container having an interior that under a partial vacuum and having an exterior that is subjected to atmospheric pressure or greater. As explained in detail hereinafter, a user of the valve 100 may selectively activate the valve 100 to equalize the pressure within the container interior with the container exterior pressure by allowing flow of exterior ambient air into the partially evacuated container interior. The valve 100 may further serve to prevent an over-pressurization of the container interior, by automatically opening to allow flow of the fluent contents from the container interior to the container exterior if the pressure in the container interior exceeds the exterior pressure by a predetermined amount.

The inventors have further found that providing an improved valve, such as the valve 100, which has multiple modes of operation, may be more cheaply and easily manufactured when compared to other types of multi-mode valves. In particular, the valve 100 may be manufactured for a cost less than complex multi-mode valves that include springs, balls, and/or a multitude of components requiring assembly.

It may be desirable to modify the valve 100 to remain closed at even greater pressure differentials in some applications, such as when (i) the valve is installed on or with a container or system in a different orientation than the one that is illustrated, (ii) the container on or with which the valve is installed is subjected to a different temperatures or pressures than those presently contemplated, or (iii) the container on which the valve is installed is likely to experience shocks, pulses, and/or impacts.

In still other applications, such as when the user (or rigid article that is used to force open the valve) has a limited available driving force (such as may be the case when a container or system is designed for a user with arthritis in the hand), it may be desirable to modify the valve 100 so that it opens when subjected to a significantly lower external force.

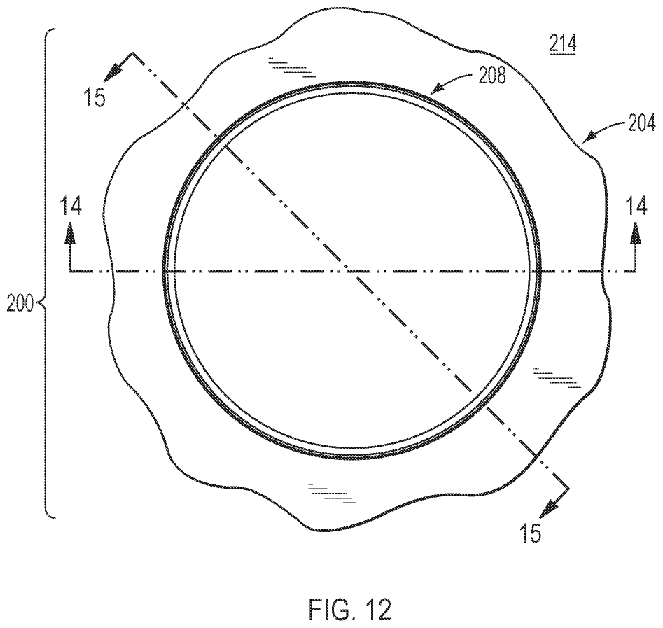

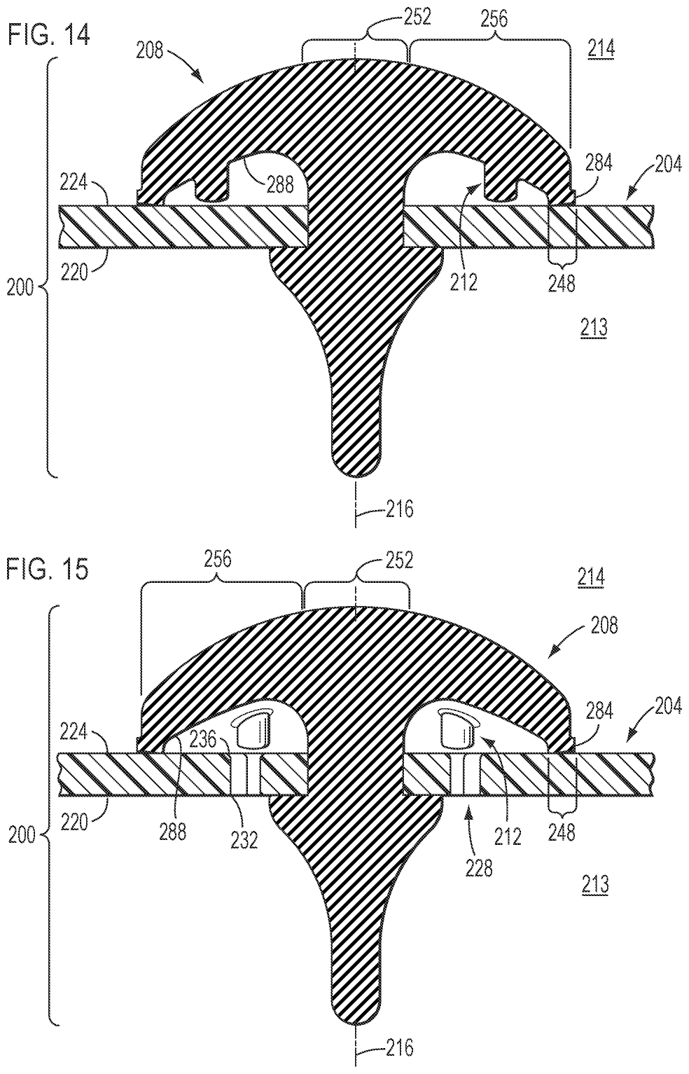

A second embodiment of a valve 200 according to the present invention is illustrated in FIGS. 12-15. The second illustrated embodiment of the valve 200 can be formed or otherwise made from the very same materials or substances that are discussed in detail above with respect to the first illustrated embodiment of the valve 100. The second illustrated embodiment of the valve 200 has the same basic elements as the first embodiment of the valve 100, namely, a relatively rigid body 204, a relatively flexible, resilient valve member 208, and a fulcrum 212 located between the body 204 and the valve member 208. As can be seen in FIGS. 14 and 15, the valve 200 has a first side 213 and a second side 214. The valve member 208 defines a central axis 216.

The second embodiment of the valve 200 functions in a similar manner as the first embodiment of the valve 100. Whereas for the first embodiment of the valve 100, three digit numerals in the one hundred series are used to refer to the features of the first embodiment features illustrated in FIGS. 1-11, three digit numerals in the two hundred series are used to refer to the features of the second embodiment of the valve 200 illustrated in FIGS. 12-15. The same last two digits in each numeral designate similar or functionally analogous elements in the two embodiments. The detailed discussion above of such features of the first embodiment of the valve 100 applies to the second embodiment of the valve 200, to the extent that such prior discussion does not contradict the ensuing discussion.

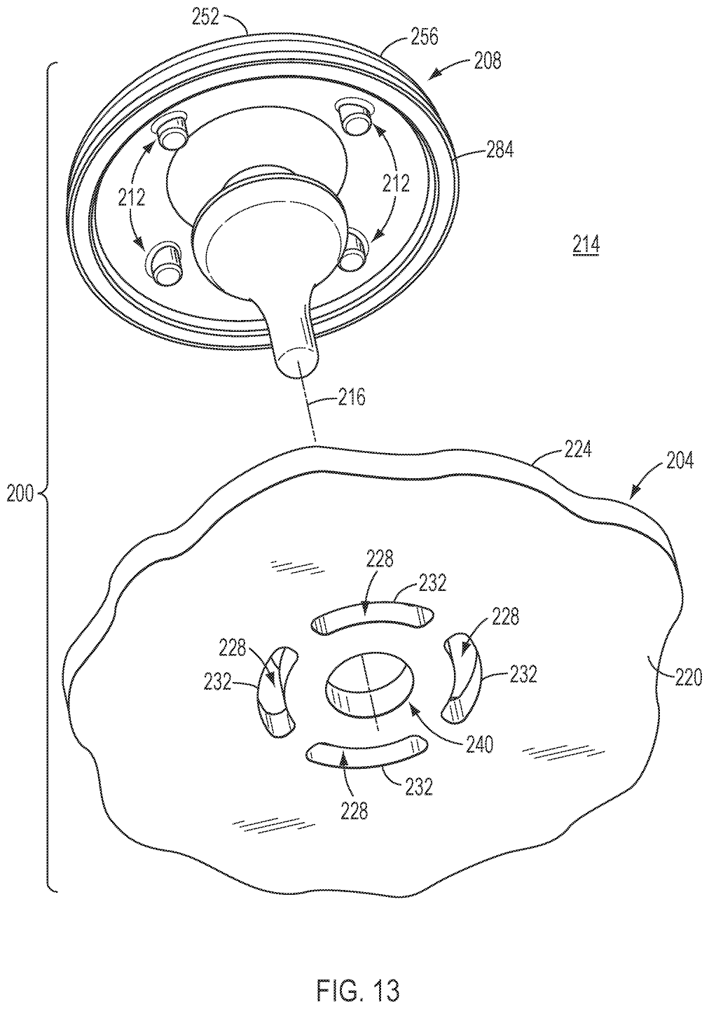

With reference to FIGS. 13-15, the body 204 defines a first side surface 220 and a second side surface 224 and includes four flow passages 228 having an opening 232 on the first side surface 220 and an opening 236 (visible in FIG. 15) on the second side surface 224. A central mounting aperture 240 extends through the body 200, along the axis 216, for receiving a portion of the valve member 208. The body second side surface 224 defines an annular valve seat 248 that is located laterally outwardly of the flow passage opening 236 on the second side surface 224.

Referring now to FIGS. 14 and 15, the valve member 208 includes a central anchor 252 and a flange 256 extending laterally outwardly therefrom. The flange 256 terminates at an annular sealing portion or lip 284 for sealing against the valve seat 248. The flange 256 further defines a bottom surface 288.

The second embodiment of the valve 200 differs from the first embodiment of the valve 100 in that the fulcrum posts 212 are located on (i.e., as part of) the bottom surface 288 of the valve member 208. The fulcrum posts 212 comprise four rounded posts 212 that extend toward the body second side surface 224. The fulcrum posts 212 function to contact the body second side surface 224 when the anchor 252 is pressed by a user of the valve 200 and moved from a first location relative to the body 204 to a second location relative to, and toward, the body 204. Contact of the fulcrum posts 212 with the body 204 functions to pivot, and lift, the lip 284 away from the valve seat 248 to thereby expose the flow passage openings 236 (FIG. 15) on the second side 224 of the body 204 to permit communication of a fluent substance through the valve 200 (in either direction). It will be understood that if the fulcrum 212 (i.e., each fulcrum post 212) is elastomeric, such as if the fulcrum posts 212 are unitarily formed with the elastomeric valve member 208, there will be more compliance in the valve 200, which will require a user to force the anchor 252 further downward to fully actuate the valve 200 open (as compared to the first embodiment of the valve 100 in which the fulcrum posts 212 are formed from a relatively more rigid thermoplastic material).

It will be understood that although the fulcrum 212 (i.e., fulcrum posts 212) of the second embodiment of the valve 200 is illustrated as unitary with the valve member 208, the fulcrum posts 212 need not be unitary with the valve member 208. For example, the fulcrum posts 212 could be initially formed separately from the valve member 208 and subsequently attached to the valve member 208 by a secondary manufacturing process (e.g., glued, bi-injection molded, heat bonded, clamped, press-fit, etc.). It will be further understood that while the fulcrum 212 of the second illustrated embodiment of the valve 200 has the form of four rounded posts 212 extending from the bottom surface 288 of the valve member 208 toward the body 204, the fulcrum 212 need not be limited to such a shape for some applications. For example, the fulcrum 212 could have the form of only a single post extending from the valve member 208. Alternatively, the fulcrum 212 could have the form of a wall extending downwardly from the valve member 208.

The second embodiment valve 200 may be more easily manufactured, and at less cost, when compared to other types of valves, such as the first embodiment valve 100.

In addition, the second embodiment valve 200, which has a fulcrum 212 located on the valve member 208, may be more desirable, or even necessary, in an application where the body 204 is a standardized and planar part that cannot be modified to accommodate a fulcrum 212.

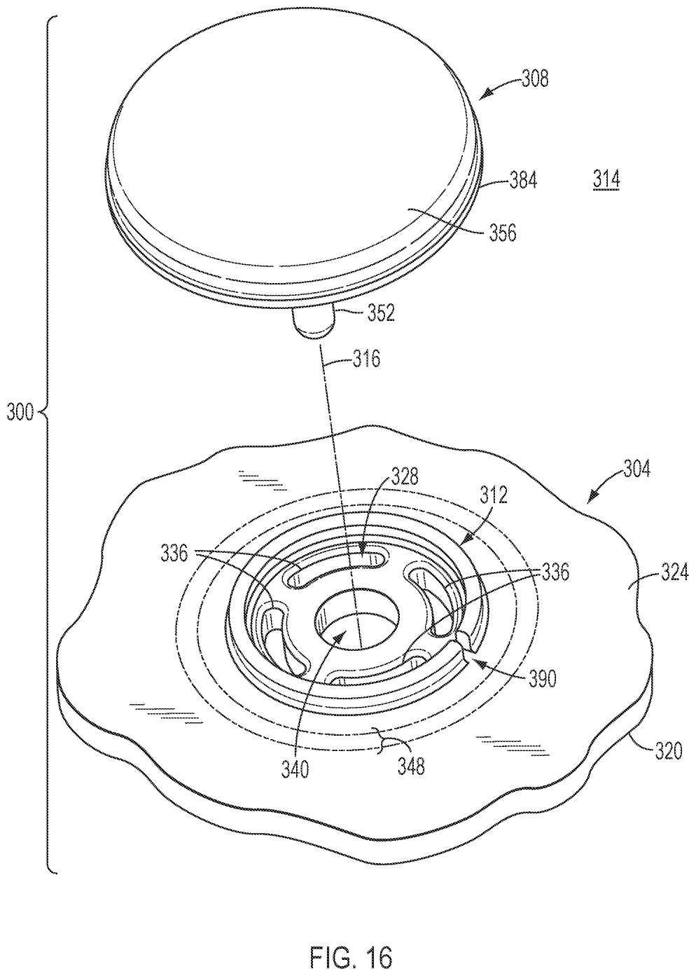

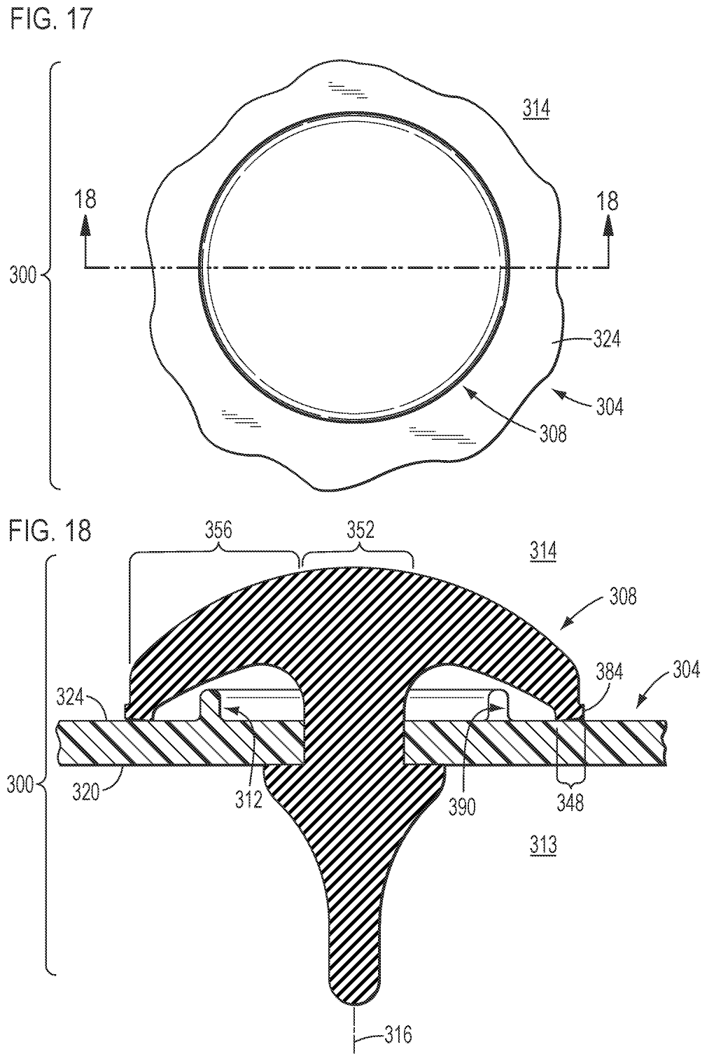

A third embodiment of a valve 300 according to the present invention is illustrated in FIGS. 16-18. As will be discussed in detail below, the third illustrated embodiment of the valve 300 functions generally in the same manner as the first illustrated embodiment of the valve 100, and includes the basic functional elements of a body 304, a valve member 308, and a fulcrum 312 to control the communication of a fluent substance between a first side 313 of the valve 300 and a second side 314 of the valve 300 (in either direction). Whereas for the first embodiment of the valve 100, three digit numerals in the one hundred series are used to refer to the first embodiment features illustrated in FIGS. 1-11, three digit numerals in the three hundred series are used to refer to the features of the third embodiment of the valve 300 in FIGS. 16-18. The same last two digits in each numeral designate similar or functionally analogous elements in the first and third embodiments. The detailed discussion above of such features of the first embodiment of the valve 100 applies to the third embodiment of the valve 300, to the extent that such preceding discussion does not contradict the following discussion.

With reference to FIGS. 16 and 18, the valve member 308 is assembled with the body 304 generally along a central axis 316. The body 304 defines a first side surface 320 and a second side surface 324. The body 304 includes four flow passages 328 (FIG. 16), each defining an opening 336 (FIG. 16) on the second side surface 324. A central mounting aperture 340 extends through the body 304, for receiving a portion of the valve member 308. The body second side surface 324 defines an annular valve seat 348 that is located laterally outwardly of the openings 336 on the second side surface 324. The valve member 308 includes a central anchor 352 and a flange 356 extending laterally outwardly therefrom. The flange 356 terminates at an annular sealing portion or lip 384 for sealing against the valve seat 348 when the valve 300 is in a normally closed position as shown in FIG. 18.

The third embodiment of the valve 300 differs from the first embodiment of the valve 100 in that the fulcrum 312 of the third embodiment of the valve 300 has the form of an annular wall 312 that extends laterally beyond and around the flow passage openings 336 on the body second side surface 324. The wall includes a slot, aperture, or channel 390 therein to permit communication of a fluent substance between the sides 313, 314 of the valve 300 when the anchor 352 is forced downward by a user of the valve 300 such that the valve member 308 contacts the top of the wall. The fulcrum 312 in the form of a wall 312 otherwise functions in the same manner as discussed above with respect to the first embodiment of the valve 100, whereby if the valve member 308 is pushed downwardly, the relative movement of the valve member 308 downwardly with respect to the body 304 causes engagement of the fulcrum wall 312 with the valve member 308, pivoting the distal end of the flange 356 upwardly, to thereby lift the lip 384 away from the valve seat 348, exposing the flow passage openings 336 (FIG. 16) to permit communication of a fluent substance through the valve via the flow passages 328 and channel 390. It will be appreciated that the fulcrum wall 312 could be modified to define a series of grooves or other discontinuities in place of a single channel 390. Also, the fulcrum wall could have the form of a series of discrete, spaced-apart, arcuate ridges. In yet another alternative, the fulcrum wall 312 could fully encircle the flow passage openings 336 a full 360 degrees, and the channel 390 could be replaced by one or more holes or other apertures extending radially through the wall to permit flow therethrough. Although the fulcrum wall 312 is illustrated as circular when viewed from above, it will further be appreciated that in some applications the wall could have other shapes, such as square, triangular, polygonal, asymmetric, or other irregular configuration.

With the valve 300 in a mechanically maintained open condition, the flow of a fluent substance may travel from a higher pressure environment on the second side 314 of the valve 300, beneath the lip 384, through the channel 390, into the flow passages 328, and to a lower pressure environment on the first side 313 of the valve 300. It will be appreciated that the flow of the fluent substance may be reversed, depending on the relative pressures between the first side 313 and second side 314 of the valve 300.

It will be understood that while the fulcrum wall 312 of the third illustrated embodiment of the valve 300 is illustrated as a wall that is unitary with the body 304, the fulcrum wall 312 need not be unitary with the body 304. For example, the fulcrum wall 312 could be initially formed or otherwise made separately from the body 304 and subsequently attached thereto by a secondary manufacturing process (e.g., adhered with adhesive, bi-injection molded, heat bonded, clamped, press-fit, etc.). Furthermore, the fulcrum wall 312 may be formed unitarily with the valve member 308 instead of being located on the valve body 304.

It will be appreciated that while various theories and explanations have been set forth herein with respect to how the component configurations and arrangements may affect the operation of the inventive valves, there is no intention to be bound by such theories and explanations. Further it is intended that all structures falling within the scope of the appended claims are not to be otherwise excluded from the scope of the claims merely because the operation of such valves may not be accounted for by the explanations and theories presented herein.

Various modifications and alterations to this invention will become apparent to those skilled in the art without departing from the scope and spirit of this invention. Illustrative embodiments and examples are provided as examples only and are not intended to limit the scope of the present invention.

1. A normally closed valve that i) can automatically open to establish communication through the valve between first and second sides of the valve in response to a pressure on the first side of the valve exceeding the pressure on the second side of the valve by a predetermined amount, and ii) can also be selectively opened to establish communication through the valve between the first and second sides of the valve, said valve comprising:
I. a body defining
A. a first side surface and a second side surface;
B. at least one flow passage extending through said body between said first side surface and said second side surface to define i) a flow passage opening at said body first side surface, and ii) a flow passage opening at said body second side surface; and
C. a valve seat that i) is located on said second side surface, and ii) encompasses said flow passage opening at said second side surface;
II. a valve member that includes
A. an anchor that is mounted on said body to accommodate movement between i) an initially installed first location relative to said body, and ii) a selectively mechanically maintainable second location relative to said body; and
B. a flange that is deflectable and resilient, and that i) extends laterally from said anchor, and ii) defines a seal portion for effecting a sealing engagement with said valve seat on said second side surface around said flow passage opening at said second side surface when said anchor is in said first location relative to said body while the pressure on the first side of said valve does not exceed the pressure on the second side of said valve by more than a predetermined amount; and
III. a fulcrum located atone of said valve member and/or said body between said flange and said second side surface whereby said valve can be selectively opened by pushing said anchor relative to said body toward said second location to pivot at least a portion of said flange about said fulcrum and thereby deflect at least part of said seal portion out of sealing engagement with said valve seat on said second side surface to open said valve to establish communication through said valve between the first and second sides of said valve.

2. The valve in accordance with claim 1 in which
said body, is a part of a container that can be subjected to a first pressure on the exterior of the container that exceeds a second pressure on the interior of the container; and
said flange is located at the exterior of said container.

3. The valve in accordance with claim 1 in which
said body has a plurality of said flow passages arranged to extend between said first side surface and said second side surface of said body; and
each of said flow passages defines a flow passage opening at said second side surface of said body so that said flow passage openings at said second side surface of said body lie on a circular locus.

4. The valve in accordance with claim 3 in which
said flange of said valve member is a flexible, resilient membrane that has a generally circular configuration extending from said anchor; and
said seal portion of said valve member is an annular lip for sealingly engaging said valve seat around said plurality of said flow passage openings at said second side surface of said body.

5. The valve in accordance with claim 1 in which
said body defines a mounting aperture extending between said first side surface and said second side surface of said body;
said anchor of said valve member has i) a middle portion received in said mounting aperture, ii) a first end portion extending beyond said mounting aperture at said first side surface of said body, and iii) a second end portion extending beyond said mounting aperture at said second side surface of said body;
said flange of said valve member is located adjacent said second side surface of said body and extends from said second end portion of said anchor; and
said first end portion of said anchor is enlarged and extends adjacent to, and engages, said first side surface of said body for inhibiting movement of said first end portion through said mounting aperture in the direction from said first side surface toward said second side surface of said body.

6. The valve in accordance with claim 5 in which said flange is sufficiently resilient so that said seal portion can engage said valve seat with a sealing force to bias said anchor to said first location wherein said enlarged first end portion of said anchor is pulled against said first side surface of said body adjacent said mounting aperture to maintain said anchor at said first location unless said anchor is moved with an external force sufficient to overcome said bias.

7. The valve in accordance with claim 1 in which said fulcrum is a post projecting from said second side surface of said body toward said valve member flange.

8. The valve in accordance with claim 1 in which said fulcrum is a post projecting from said flange of said valve member toward said second side surface of said body.

9. The valve in accordance with claim 1 in which said fulcrum is an annular wall that
i) projects from said second side surface of said body toward said flange of said valve member, and
ii) extends around said flow passage opening at said second side surface, and
said annular wall defines at least one channel therein to accommodate flow through said channel when said flange engages said annular wall.

10. The valve in accordance with claim 1 in which said fulcrum is an annular wall that
i) projects from said flange of said valve member toward said second side surface of said body around said flow passage opening at said second side surface,
ii) is spaced laterally from said seal portion of said valve member, and
iii) is configured to engage said second side surface around said flow passage opening at said second side surface, and
said annular wall defines at least one channel therein to accommodate flow through said channel when said annular wall engages said second side surface around said flow passage opening at said second side surface.

11. The valve in accordance with claim 1 wherein said valve member is formed from Silicone having a durometer of about 40 Shore A.

12. The valve in accordance with claim 1 wherein said flange includes a top surface that faces away from said second side surface of said body and which defines a radius of curvature, said flange further includes a bottom surface that faces said second side surface and which defines a radius of curvature, and wherein said radius of curvature of said bottom surface is greater than said radius of curvature of said top surface.

13. The valve in accordance with claim 1 wherein said valve is configured to automatically open to establish communication through the valve when the pressure on the first side of the valve exceeds the pressure on the second side of the valve by about 20,600 Pascal.

14. The valve in accordance with claim 1 wherein said valve member is mechanically maintainable in said second location relative to said body when said anchor of said valve member is subjected to a pre-determined manual compressive force.

15. The valve in accordance with claim 1 wherein said anchor defines a central axis and said fulcrum is located radially outwardly of said flow passage opening at said body second side surface, as measured from said central axis.

16. The valve in accordance with claim 1 wherein said fulcrum has the form of four rounded posts located on one of said valve member and/or said second side surface of said body, said posts located on a circular locus.

17. The valve in accordance with claim 1 wherein said body includes four flow passages each of which has the form of an arcuate slot extending between said first side surface and said second side surface of said body.

18. The valve is in accordance with claim 1 in which said body is a molded thermoplastic insert for a container that can be subjected to a first pressure on the exterior of the container that exceeds a second pressure on the interior of the container;
said valve member is a molded elastomer; and
said valve member arranged with said body such that the flange of said valve member is located at the exterior of said container.

19. The valve is in accordance with claim 1 in combination with a container in the form of a flexible pouch, said valve located at an opening of said pouch.

20. A valve comprising:
I. a body having a first side surface and a second side surface, said body defining at least one flow passage extending through said body between said first side surface and said second side surface to define
i) a flow passage opening at said first side surface, and
ii) a flow passage opening at said second side surface;
II. a valve member that
i) is movable relative to said body, and
ii) includes a flexible and resilient flange having a first region, a second region extending from said first region, and a third region extending from said second region; said third region including a seal portion configured so that said seal portion sealingly engages said second side surface around said flow passage opening at said second side surface when said valve is in an initially closed condition to prevent communication through said valve; and
III. a fulcrum that is located at one of said valve member and/or said body between said second region and said second side surface whereby if said valve member is pushed relative to said body to move said first region toward said second side surface, then said second region pivots about said fulcrum to deflect at least part of said sealing portion of said third region out of sealing engagement with said second side surface to establish communication through said valve.

21.-40. (canceled)
